(19) United States
(12) Patent Application Publication
(10) Pub. No.: US 2025/0271956 A1
(43) Pub. Date: Aug. 28, 2025

(54) TOUCH DRIVER AND DISPLAY DEVICE INCLUDING THE SAME

(71) Applicant: SAMSUNG DISPLAY CO., LTD., YONGIN-SI (KR)

(72) Inventors: BO-HWAN LEE, Yongin-si (KR); SANGHUN PARK, Yongin-si (KR); YOUNGMIN PARK, Yongin-si (KR); YONGSUB SO, Yongin-si (KR); HOEUNG LEE, Yongin-si (KR); BYEONGKYU JEON, Yongin-si (KR)

(21) Appl. No.: 18/973,021

(22) Filed: Dec. 8, 2024

(30) Foreign Application Priority Data
Feb. 27, 2024 (KR) 10-2024-0027803

(51) Int. Cl. G06F 3/041

(52) U.S. Cl. CPC G06F 3/0412

(57) ABSTRACT

A display device including: a display panel including a pixel; a touch panel including a touch sensor; and a display panel driver configured to perform a data writing operation to the pixel in an active period and perform a touch driving operation to the touch sensor in a blank period, wherein the display panel driver includes a touch driver configured to perform the tough driving operation and a driving controller configured to control an operation of the display panel and the touch driver, and wherein the touch driver outputs a touch driving performing signal, which indicates that the touch driving operation was performed, in the blank period to the driving controller.

### CROSS-REFERENCE TO RELATED APPLICATION(S)

This application claims priority under 35 U.S.C. § 119 to Korean Patent Application No. 10-2024-0027803, filed on Feb. 27, 2024 in the Korean Intellectual Property Office (KIPO), the disclosure of which is incorporated by reference herein in its entirety.

### 1. Technical Field

Embodiments of the present inventive concept relate to a touch driver and a display device including the touch driver. More particularly, the touch driver and the display device including the touch driver improve display quality.

### 2. Description of the Related Art

A display device typically includes a display panel and a display panel driver. The display panel includes a plurality of gate lines, a plurality of data lines and a plurality of pixels. The display panel driver includes a gate driver that provides a gate signal to the gate lines, a data driver that provides a data voltage to the data lines and a driving controller that controls the gate driver and the data driver.

When touch driving and panel driving are performed during a blank period, the touch driving signal may interfere with a panel driving signal.

### SUMMARY

Some embodiments of the present inventive concept provide a touch driver that enhances the reliability of touch driving during a blank period.

Some embodiments of the present inventive concept provide a display device including the touch driver.

According to an embodiment of the present inventive concept, there is provided a display device including: a display panel including a pixel; a touch panel including a touch sensor; and a display panel driver configured to perform a data writing operation to the pixel in an active period and perform a touch driving operation to the touch sensor in a blank period, wherein the display panel driver includes a touch driver configured to perform the tough driving operation and a driving controller configured to control an operation of the display panel and the touch driver, and wherein the touch driver outputs a touch driving performing signal, which indicates that the touch driving operation was performed, in the blank period to the driving controller.

The touch driver receives an active period completion signal from the driving controller and performs the touch driving operation in response to the active period completion signal.

A touch driving period in which the touch driving operation is performed includes a touch signal applying period in which a touch signal is applied to the touch panel, a touch signal receiving period in which a touch sensing signal is applied to the touch driver, and a touch calculating period in which the touch sensing signal is calculated, and the touch driver outputs the touch driving performing signal after the touch calculating period.

A touch driving period in which the touch driving operation is performed includes a touch signal applying period in which a touch signal is applied to the touch panel, a touch signal receiving period in which a touch sensing signal is applied to the touch driver, and a touch calculating period in which the touch sensing signal is calculated, and the touch driver outputs the touch driving performing signal after the touch signal receiving period.

A touch driving period in which the touch driving operation is performed includes a touch signal applying period in which a touch signal is applied to the touch panel and a touch signal receiving period in which a touch sensing signal is applied to the touch driver, and the touch driver outputs the touch driving performing signal after the touch signal receiving period.

The touch driver outputs the touch driving performing signal immediately after the touch signal receiving period.

The display panel driver further includes a sensing driver, and the sensing driver performs a sensing operation to the pixel based on the touch driving performing signal.

The driving controller outputs a sensing start signal to the sensing driver in response to the touch driving performing signal, and the sensing driver performs the sensing operation in response to the sensing start signal.

The touch driver includes: a completion signal receiving circuit configured to receive an active period completion signal from the driving controller; a touch signal applying circuit configured to apply a touch signal to the touch sensor in response to the active period completion signal; a touch sensing signal receiving circuit configured to receive a touch sensing signal from the touch sensor and to output a sensing completion signal; and a completion signal outputting circuit configured to receive the sensing completion signal and to output the touch driving performing signal.

The touch driver further includes a touch sensing signal calculating circuit configured to calculate the touch sensing signal, the touch sensing signal calculating circuit outputs a calculating completion signal to the completion signal outputting circuit, and the completion signal outputting circuit outputs the touch driving performing signal in response to the calculating completion signal.

The driving controller generates a blank operating signal in response to the touch driving performing signal.

According to an embodiment of the present inventive concept, there is provided a display device including: a display panel including a pixel; a touch panel including a touch sensor; and a display panel driver configured to perform a data writing operation to the pixel in an active period and perform a touch driving operation to the touch sensor in a blank period, wherein the touch driving operation includes: a touch signal applying operation in which a touch signal is applied to the touch panel; a touch sensing signal receiving operation in which a touch sensing signal is received from the touch panel; and a touch sensing signal calculating operation in which touch sensing data is calculated based on the touch sensing signal, and wherein the display panel driver generates a touch driving performing signal after the touch sensing signal receiving operation is performed.

The touch driving performing signal is generated after the touch sensing signal calculating operation is performed.

The display panel driver includes: a touch driver configured to perform the touch driving operation; and a driving controller configured to control an operation of the display panel and the touch driver, and the touch driver outputs the touch driving performing signal to the driving controller.

The driving controller outputs an active period completion signal to the touch driver, and the touch driver performs the touch driving operation in response to the active period completion signal.

The driving controller generates a blank operating signal in response to the touch driving performing signal.

The display panel driver further includes a sensing driver configured to perform a sensing operation to the pixel, the blank operating signal includes a sensing start signal, and the sensing driver performs the sensing operation in response to the sensing start signal.

According to an embodiment of the present inventive concept, there is provided a touch driver including: a completion signal receiving circuit configured to receive an active period completion signal; a touch signal applying circuit configured to generate a touch signal in response to the active period completion signal; a touch sensing signal receiving circuit configured to receive a touch sensing signal generated by a touch sensor based on the touch signal; and a completion signal outputting circuit configured to receive a sensing completion signal from the touch sensing signal receiving circuit and to output a touch driving performing signal to a driving controller.

The touch driver further includes a touch sensing signal calculating circuit configured to calculate the touch sensing signal.

The touch sensing signal calculating circuit outputs a calculating completion signal to the completion signal outputting circuit, and the completion signal outputting circuit outputs the touch driving performing signal in response to the calculating completion signal.

As described above, with the touch driver and the display device including the same, the touch driving operation of the display device can output a touch driving performing signal after the touch signal receiving period. The display panel driver may then perform a blank period operation in response to the touch driving performing signal. Accordingly, signal interference between the touch driving operation and the blank period operation is reduced. By reducing signal interference, the reliability of the blank period operation is enhanced. Additionally, this reduction in signal interference also improves the reliability of the touch driving operation.

Furthermore, because the display panel driver performs the blank period operation in response to the touch driving performing signal, the variety of blank period operations that can be performed may increase.

### BRIEF DESCRIPTION OF THE DRAWINGS

Illustrative, non-limiting embodiments of the present inventive concept will be more clearly understood from the following detailed description, taken in conjunction with the accompanying drawings.

FIG. 1 is a block diagram illustrating a display device according to embodiments of the present inventive concept.

FIG. 2A is a block diagram illustrating a display device according to an embodiment of the present inventive concept.

FIG. 2B is a cross-sectional view illustrating a display panel according to an embodiment of the present inventive concept.

FIG. 2C is a cross-sectional view illustrating a display panel according to an embodiment of the present inventive concept.

FIG. 3 is a circuit diagram illustrating an example of a pixel included in a display panel of FIG. 1.

FIG. 4 is a block diagram illustrating an example of a touch driver and a touch panel included in a display device of FIG. 1.

FIG. 5 is a block diagram illustrating an example of a driving controller, a touch driver and a touch panel included in the display device of FIG. 1.

FIG. 6 is a block diagram illustrating an example of a touch driver and a touch panel included in a display panel of FIG. 1.

FIG. 7 is a timing diagram illustrating an operation performed in a frame period of the display device of FIG. 1.

FIG. 8 is a timing diagram illustrating an example of an operation performed in a frame period of the display device of FIG. 1.

FIG. 9 is a timing diagram illustrating an example of an operation performed in a frame period of the display device of FIG. 1.

FIG. 10 is a block diagram illustrating an electronic device according to an embodiment of the present inventive concept.

FIG. 11 is a diagram illustrating an example in which the electronic device of FIG. 10 is implemented as a smart phone.

### DETAILED DESCRIPTION OF THE INVENTIVE CONCEPT

Hereinafter, embodiments of the present inventive concept will be explained in detail with reference to the accompanying drawings.

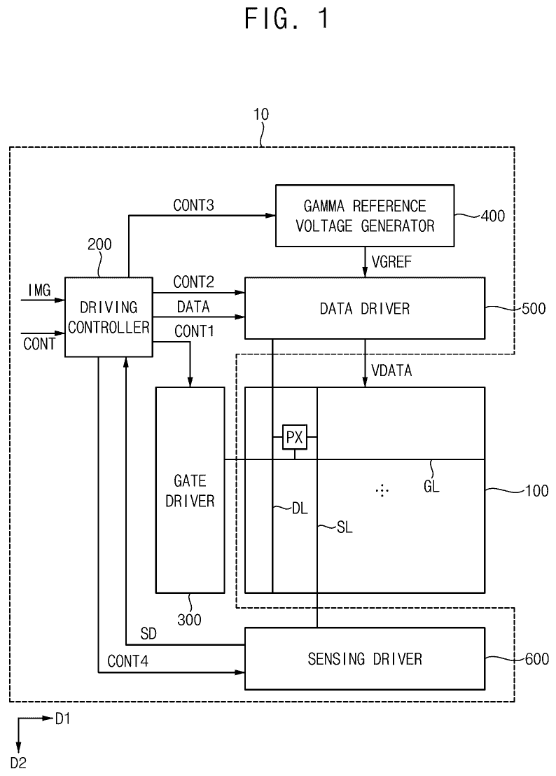

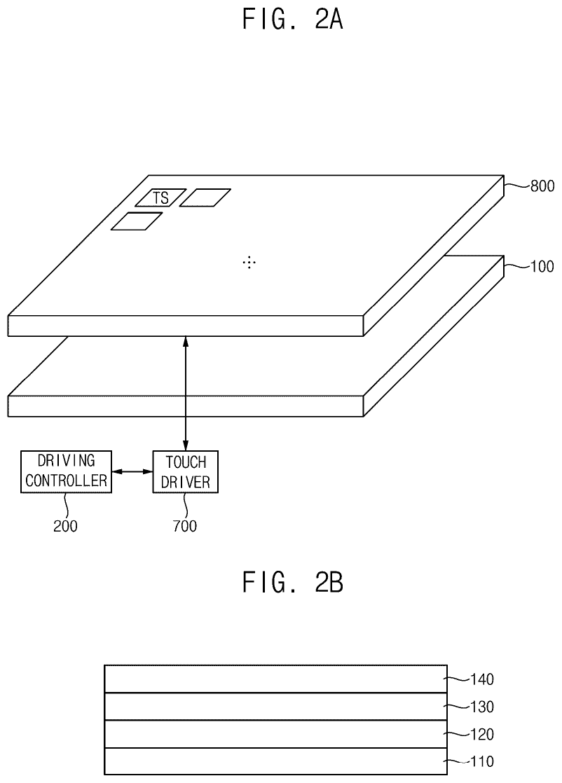

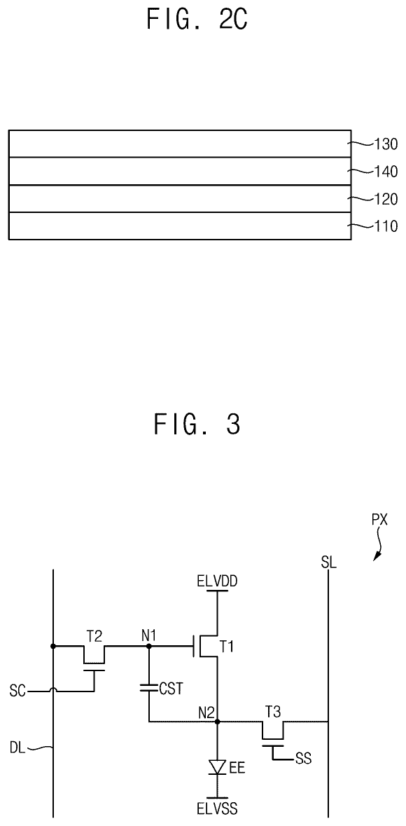

FIG. 1 is a block diagram illustrating a display device according to embodiments of the present inventive concept. FIG. 2A is a block diagram illustrating a display device according to an embodiment of the present inventive concept. FIG. 2B is a cross-sectional view illustrating a display panel according to an embodiment of the present inventive concept. FIG. 2C is a cross-sectional view illustrating a display panel according to an embodiment of the present inventive concept.

Referring to FIG. 1 to FIG. 2C, the display device includes a display panel 100, a display panel driver 10. In the present embodiment, the display device may further include a touch panel 800 disposed on the display panel 100 and a touch driver 700 for driving the touch panel 800.

The display panel driver 10 may include a driving controller 200, a gate driver 300, a gamma reference voltage generator 400 and a data driver 500. In the present embodiment, the display panel driver 10 may further include the touch driver 700.

The display panel 100 may have a display region on which an image is displayed and a peripheral region adjacent to the display region.

The display panel 100 may include a plurality of gate lines GL, a plurality of data lines DL and a plurality of pixels PX connected to the gate lines GL and the data lines DL. The gate lines GL may extend in a first direction D1. The data line DL may extend in a second direction D2 crossing the first direction D1.

The display panel driver 10 may include the gate driver 300 for providing a gate signal to the pixels PX, the data driver 500 connected to the pixels PX through the data lines DL, the touch driver 700 for driving the touch panel 800 and the driving controller 200 for controlling the gate driver 300, the data driver 500 and the touch driver 700. In an embodiment, the display panel driver 10 may further include a sensing driver 600. The driving controller 200 may control the sensing driver 600. The sensing driver 600 may be connected to the pixels PX through a sensing line SL.

The driving controller 200 may receive input image data IMG and an input control signal CONT from a host processor and/or a graphic process unit. For example, the input image data IMG may include red image data, green image data and blue image data. For example, the input image data IMG may include white image data. For example, the input image data IMG may include magenta image data, yellow image data and cyan image data. The input control signal CONT may include a master clock signal and a data enable signal. The input control signal CONT may further include a vertical synchronizing signal and a horizontal synchronizing signal. The driving controller 200 may control a driving of the display panel 100. In other words, the driving controller 200 may control the operation of the display panel 100.

The driving controller 200 may generate a first control signal CONT1, a second control signal CONT2, a third control signal CONT3 and a data signal DATA based on the input image data IMG and the input control signal CONT. In an embodiment, the driving controller 200 may generate a fourth control signal CONT4 based on the input image data IMG and the input control signal CONT.

The driving controller 200 may generate the first control signal CONT1 to control an operation of the gate driver 300 based on the input control signal CONT, and output the first control signal CONT1 to the gate driver 300. The first control signal CONT1 may include a vertical start signal and a scan clock signal.

The driving controller 200 may generate the third control signal CONT3 to control an operation of the gamma reference voltage generator 400 based on the input control signal CONT, and output the third control signal CONT3 to the gamma reference voltage generator 400.

The driving controller 200 may generate the second control signal CONT2 to control an operation of the data driver 500 based on the input control signal CONT, and output the second control signal CONT2 to the data driver 500. The second control signal CONT2 may include a horizontal start signal and a load signal.

The driving controller 200 may generate the data signal DATA based on the input image data IMG and the input control signal CONT. The driving controller 200 may output the data signal DATA to the data driver 500.

In an embodiment, the driving controller 200 may generate the fourth control signal CONT4 to control an operation of the sensing driver 600 based on the input control signal CONT, and output the fourth control signal CONT4 to the sensing driver 600. In an embodiment, the fourth control signal CONT4 may include a blank operating signal.

The gate driver 300 may generate gate signal to drive the gate lines GL in response to the first control signal CONT1 received from the driving controller 200. The gate driver 300 may output the gate signal to the gate lines GL.

The gamma reference voltage generator 400 may generate a gamma reference voltage VGREF in response to the third control signal CONT3 received from the driving controller 200. The gamma reference voltage generator 400 may provide the gamma reference voltage VGREF to the data driver 500. The gamma reference voltage VGREF has a value corresponding to each data signal DATA. For example, the gamma reference voltage generator 400 may be disposed in the driving controller 200 or in the data driver 500.

The data driver 500 may receive the second control signal CONT2 and the data signal DATA from the driving controller 200 and receive the gamma reference voltages VGREF from the gamma reference voltage generator 400. The data driver 500 may convert the data signal DATA into a data voltage VDATA having an analog type using the gamma reference voltages VGREF. In other words, the data driver 500 may convert the data signal DATA into an analog-type data voltage using the gamma reference voltages VGREF. The data driver 500 may output the data voltage VDATA to the data lines DL.

In an embodiment, the data driver 500 may be implemented with one or more integrated circuits. In another embodiment, the data driver 500 and the driving controller 200 may be implemented as a single integrated circuit and the single integrated circuit may be referred to as a timing controller embedded data driver (TED).

The sensing driver 600 may receive the fourth control signal CONT4 from the driving controller 200. For example, the fourth control signal CONT4 may include a sensing start signal. The sensing driver 600 may generate sensing data SD by sensing the pixels PX through the sensing lines SL. For example, the sensing driver 600 may determine a driving characteristic, such as mobility and/or threshold voltage, of the driving transistor by measuring the sensing current or sensing voltage of a driving transistor in the pixels PX via the sensing line SL. This process of measuring the driving characteristic, such as mobility or threshold voltage, of the driving transistor is referred to as a sensing operation. The sensing driver 600 may generate the sensing data SD by performing the sensing operation. The sensing driver 600 may output the sensing data SD to the driving controller 200. The sensing data SD may include information about the driving characteristic of the driving transistor.

In an embodiment, the sensing driver 600 may be implemented with a separate integrated circuit from an integrated circuit of the data driver 500. In other embodiments, the sensing driver 600 may be included in the data driver 500 or may be included in the driving controller 200.

Additionally, in an embodiment, the display panel driver 10 may not include the sensing driver 600. The present inventive concept is not limited to a type of a driver included in the display panel driver 10.

The touch panel 800 may include a touch sensor TS.

In FIG. 2A, the touch panel 800 may be disposed outside of the display panel 100. Alternatively, the touch panel 800 and the display panel 100 may be integrally formed.

Referring to FIG. 2B, the display panel 100 may include a base substrate 110, a display layer 120 disposed on the base substrate 110, an encapsulation layer 130 disposed on the display layer 120 and a touch layer 140 disposed on the encapsulation layer 130. The display layer 120 may include a light emitting element. The touch layer 140 may include a touch sensor TS.

Referring to FIG. 2C, the display panel 100 may include a base substrate 110, a display layer 120 disposed on the base substrate 110, a touch layer 140 disposed on the display layer 120 and an encapsulation layer 130 disposed on the touch layer 140. Unlike FIG. 2B, the touch layer 140 is provided between the encapsulation layer 130 and the display layer 120. The display layer 120 may include a light emitting element. The touch layer 140 may include a touch sensor TS.

The touch driver 700 may apply a touch signal to the touch sensor TS. The touch driver 700 may sense a touch sensing voltage of the touch sensor TS. For example, the touch sensing voltage may be referred to as a touch sensing signal. In the present embodiment, the touch driver 700 may receive the touch sensing signal from the touch sensor TS. The touch driver 700 may drive the touch sensor TS. For example, the touch driver 700 may perform a touch driving operation on the touch sensor TS. In the present embodiment, the driving controller 200 may output a signal to the touch driver 700. The touch driver 700 may output a signal to the driving controller 200. In the present embodiment, the driving controller 200 may control the driving of the display panel 100 and an operation of the touch driver 700.

In the present embodiment, the touch driving operation may include a touch signal applying operation and a touch sensing signal receiving operation. In an embodiment, the touch driving operation may further include a touch sensing signal calculating operation. The touch signal applying operation may refer to the process of applying the touch signal to the touch sensor TS. The touch sensing signal receiving operation may refer to the process of receiving the touch sensing signal from the touch sensor TS. In an embodiment, the touch sensing signal calculating operation may refer to the process of calculating the touch sensing signal.

In the present embodiment, a frame period in which the display panel 100 is driven may include an active period and a blank period. The display panel driver 10 may apply the data voltage VDATA to the pixel PX during the active period. The display panel driver 10 may perform the touch driving operation in the blank period. In the blank period, the data voltage VDATA may not be applied to the pixel PX.

FIG. 3 is a circuit diagram illustrating an example of a pixel PX included in a display panel of FIG. 1.

Referring to FIG. 1 to FIG. 3, for example, the pixel PX may include a first transistor T1, a second transistor T2, a third transistor T3, a storage capacitor CST and a light emitting element EE. The gate signal may include a scan gate signal SC and a sensing gate signal SS.

The storage capacitor CST may store the data voltage VDATA applied from the data line DL. In an embodiment, the storage capacitor CST may include a first electrode connected to a first node N1 and a second electrode connected to a second node N2.

The second transistor T2 may apply the data voltage VDATA to the first node N1 in response to the scan gate signal SC. The second transistor T2 may include a control electrode for receiving the scan gate signal SC, a first electrode for receiving the data voltage VDATA and a second electrode connected to the first node N1. An operation of the second transistor T2 applying the data voltage VDATA to the first node N1 may be referred to as a data writing operation. In other words, the operation in which the second transistor T2 applies the data voltage VDATA to the first node N1 may be referred to as a data writing operation.

The third transistor T3 may connect the sensing line SL and the second node N2 in response to the sensing gate signal SS. In an embodiment, the third transistor T3 may include a control electrode for receiving the sensing gate signal SS, a first electrode connected to the sensing line SL and a second electrode connected to the second node N2.

The first transistor T1 may generate a driving current based on the data voltage VDATA stored in the storage capacitor CST. In an embodiment, the first transistor T1 may include a control electrode connected to the first node N1, a first electrode for receiving a first power voltage (e.g., a high power voltage) and a second electrode connected to the second node N2.

The light emitting element EE may emit light based on the driving current generated by the first transistor T1. In an embodiment, the light emitting element EE may include an organic light emitting diode (OLED), a nano light emitting diode (NED), a quantum dot (QD) light emitting diode, a micro light emitting diode, an inorganic light emitting diode, or any other suitable light emitting element. In an embodiment, the light emitting element EE may include an anode connected to the second node N2 and a cathode for receiving a second power voltage (e.g., a low power voltage). However, the present inventive concept is not limited to a structure of the pixel PX. Additionally, the present inventive concept is not limited to the number of transistors and capacitors included in the pixel PX.

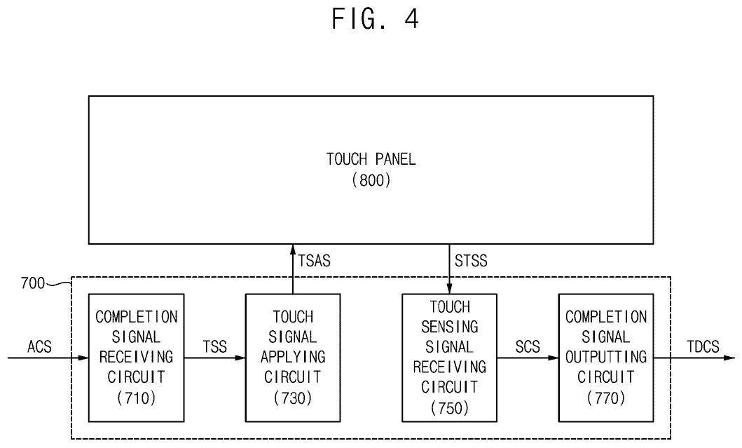

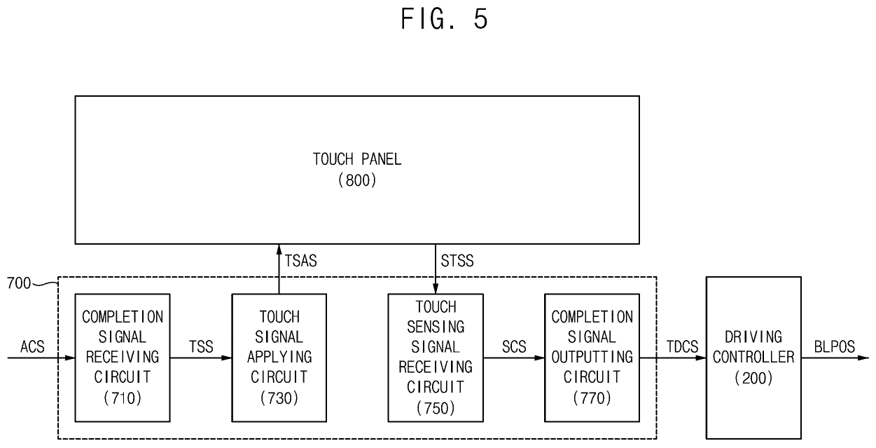

FIG. 4 is a block diagram illustrating an example of a touch driver 700 and a touch panel 800 included in a display device of FIG. 1. FIG. 5 is a block diagram illustrating an example of a driving controller 200, a touch driver 700 and a touch panel 800 included in the display device of FIG. 1.

Referring to FIG. 1 to FIG. 5, in the present embodiment, the touch driver 700 may include a completion signal receiving circuit 710, a touch signal applying circuit 730, a touch sensing signal receiving circuit 750 and a completion signal outputting circuit 770.

The completion signal receiving circuit 710 may receive an active completion signal ACS from the driving controller 200. The active completion signal ACS may output at the time when the active period of the frame period ends. In other words, the active completion signal ACS may be output when the active period of the frame period ends. For example, the active completion signal ACS may be output when the blank period of the frame period starts. The completion signal receiving circuit 710 may output a touch driving start signal TSS in response to the active completion signal ACS.

The touch signal applying circuit 730 may receive the touch driving start signal TSS. The touch signal applying circuit 730 may output a touch signal TSAS to the touch panel 800 in response to the touch driving start signal TSS. In an embodiment, the touch signal applying circuit 730 may directly receive the active completion signal ACS. The touch signal applying circuit 730 may output the touch signal TSAS in response to the active completion signal ACS when it is directly applied to the touch signal applying circuit 730.

The touch sensing signal receiving circuit 750 may receive a touch sensing signal STSS from the touch panel 800. The touch sensing signal receiving circuit 750 may output a sensing completion signal SCS. The sensing completion signal SCS may be outputted after the touch sensing signal STSS is applied to the touch sensing signal receiving circuit 750. For example, the touch panel 800 may include the touch sensor TS. For example, the touch panel 800 may output the touch sensing signal STSS generated by the touch sensors TS. For example, the sensing completion signal SCS may be outputted after all of the touch sensing signals STSS are outputted.

The completion signal outputting circuit 770 may receive the sensing completion signal SCS from the touch sensing signal receiving circuit 750. The completion signal outputting circuit 770 may generate a touch driving performing signal TDCS in response to the sensing completion signal SCS. The completion signal outputting circuit 770 may output the touch driving performing signal TDCS.

The driving controller 200 may receive the touch driving performing signal TDCS from the completion signal outputting circuit 770. The driving controller 200 may output a blank operation signal BLPOS in response to the touch driving performing signal TDCS. The display panel driver 10 may perform a blank period operation in response to the blank operation signal BLPOS. The blank period operation may be referred to as an operation performed on the display panel 100 in the blank period. For example, the blank period operation may include the sensing operation. For example, the blank operation signal BLPOS may include the sensing start signal. For example, the sensing driver 600 may perform the sensing operation in response to the blank operation signal BLPOS. For example, the sensing driver 600 may perform the sensing operation in response to the sensing start signal. However, the present inventive concept is not limited to operations included in the blank period operation. For example, the blank period operation may involve generating the data voltage VDATA that reflects the panel temperature characteristic of the display panel 100.

In a conventional display device, a touch driver does not generate a signal after the touch driving operation is completed. In contrast, the touch driver 700 of the display device can output a touch driving performing signal TDCS after the touch driving operation is finished. The display panel driver 10 may then perform a blank period operation in response to the touch driving performing signal TDCS. As a result, signal interference between the touch driving operation and the blank period operation can be reduced. Reducing this signal interference improves the reliability of both the blank period operation and the touch driving operation. Furthermore, because the display panel driver 10 performs the blank period operation in response to the touch driving performing signal TDCS, the variety of operations that can be performed during the blank period may increase.

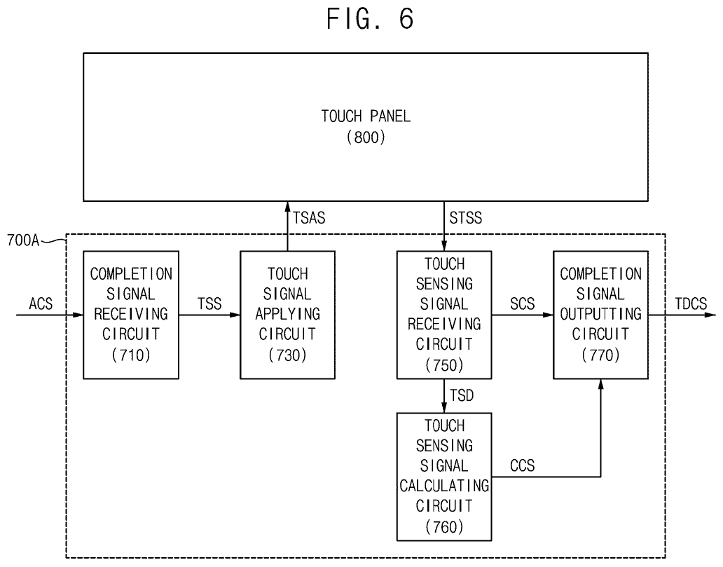

FIG. 6 is a block diagram illustrating an example of a touch driver 700A and a touch panel 800 included in a display panel of FIG. 1.

The touch driver 700A shown in FIG. 6 is substantially same as the touch driver 700 of FIG. 4 except that the touch driver 700A further includes a touch sensing signal calculating circuit 760. Therefore, the same reference numerals will be used to denote identical elements, and any repetitive explanations regarding these elements will be omitted.

Referring to FIG. 6, the touch driver 700A may further include the touch sensing signal calculating circuit 760.

The touch sensing signal calculating circuit 760 may receive touch sensing data TSD from the touch sensing signal receiving circuit 750. The touch sensing signal calculating circuit 760 may calculate the touch sensing data TSD. For example, the touch sensing signal calculating circuit 760 may determine a touch characteristic (e.g., a touch location, a touch pressure, etc.) of the touch panel 800 based on the touch sensing data TSD. The touch sensing signal calculating circuit 760 may output a calculating completion signal CCS after calculating the touch sensing data TSD. In an embodiment, the touch sensing signal calculating circuit 760 may be included in the touch sensing signal receiving circuit 750.

For example, the touch sensing signal STSS may be generated in response to a user's touch. When the user touches the touch panel 800, at least one of the touch sensors TS included in the touch panel 800 may generate the touch sensing signal STSS. The touch sensing data TSD may be generated based on the touch sensing signal STSS. A touch region on the touch panel may be determined from the touch sensing data TSD. Additionally, the touch characteristic of the touch panel 800 may be determined based on touch sensing data TSD.

In the present embodiment, the completion signal outputting circuit 770 may output the touch driving performing signal TDCS in response to the calculating completion signal CCS.

In a conventional display device, a touch driver does not generate a signal after the touch driving operation is completed. In contrast, the touch driver 700 of the display device can output a touch driving performing signal TDCS after the touch driving operation is finished. The display panel driver 10 may then perform a blank period operation in response to the touch driving performing signal TDCS. As a result, signal interference between the touch driving operation and the blank period operation can be reduced. Reducing this signal interference improves the reliability of both the blank period operation and the touch driving operation. Furthermore, because the display panel driver 10 performs the blank period operation in response to the touch driving performing signal TDCS, the variety of operations that can be performed during the blank period may increase.

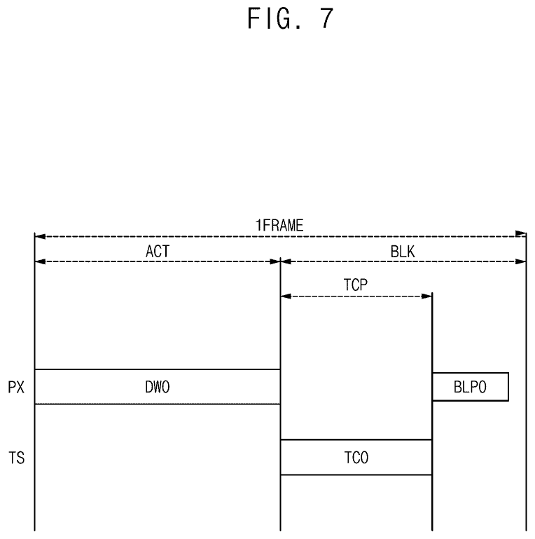

FIG. 7 is a timing diagram illustrating an operation performed in a frame period of the display device of FIG. 1.

Referring to FIG. 1 to FIG. 7, a data writing operation DWO may be performed in an active period ACT. A touch driving operation TCO may be performed in a blank period BLK. The touch driving operation TCO may be performed in a touch driving period TCP. The touch driving performing signal TDCS may be outputted after the touch driving period TCP. In an embodiment, the touch driving performing signal TDCS may be outputted immediately after the touch driving period TCP. The blank period operation BLPO may be performed after the touch driving period TCP. For example, the blank period operation BLPO may be performed in response to the touch driving performing signal TDCS after the touch driving period TCP. The blank period operation BLPO may be performed after the touch driving period TCP in the blank period BLK. The blank period operation BLPO may not overlap with the touch driving operation TCO.

The touch driver 700 of the display device may output the touch driving performing signal TDCS after the touch driving period TCP. The display panel driver 10 may perform the blank period operation BLPO in response to the touch driving performing signal TDCS. Accordingly, signal interference between the touch driving operation TCO and the blank period operation BLPO may be reduced. Due to this reduction in signal interference, the reliability of the blank period operation BLPO is improved. Additionally, the reliability of the touch driving operation TCO may be improved. Additionally, the display panel driver 10 may perform the blank period operation BLPO in response to the touch driving performing signal TDCS, allowing for an increase in the types of the blank period operations BLPO that can be performed in the blank period.

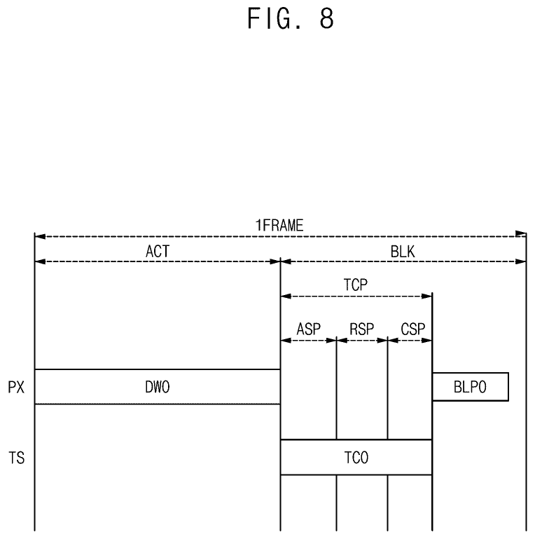

FIG. 8 is a timing diagram illustrating an example of an operation performed in a frame period of the display device of FIG. 1.

Referring to FIG. 1 to FIG. 8, the touch driving period TCP may include a touch signal applying period ASP, a touch signal receiving period RSP and a touch calculating period CSP. These periods may be arranged in sequence. In the touch signal applying period ASP, the touch driver 700 may apply the touch signal TSAS to the touch sensor TS. In the touch signal receiving period RSP, the touch driver 700 may receive the touch sensing signal STSS from the touch panel 800. In the touch calculating period CSP, the touch driver 700 may calculate the touch sensing signal STSS. For example, in the touch calculating period CSP, the touch driver 700 may calculate the touch sensing data TSD. In the present embodiment, the touch driving performing signal TDCS may be outputted after the touch calculating period CSP. In an embodiment, the touch driving performing signal TDCS may be outputted immediately after the touch calculating period CSP. The blank period operation BLPO may be performed after the touch calculating period CSP. For example, the blank period operation BLPO may be performed in response to the touch driving performing signal TDCS after the touch calculating period CSP. The blank period operation BLPO may be performed after the touch calculating period CSP in the blank period BLK.

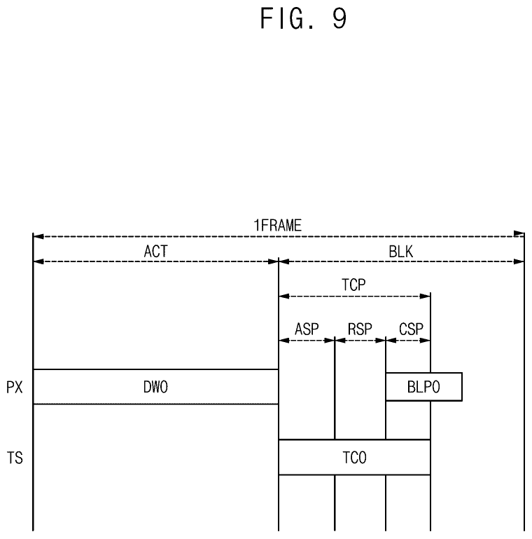

FIG. 9 is a timing diagram illustrating an operation performed in a frame period of the display device of FIG. 1.

The timing diagram in FIG. 9 is substantially same as the timing diagram of FIG. 8, except for the period in which the blank period operation BLPO is performed. Therefore, the same reference numerals will be used for identical elements, and any repetitive explanation regarding these elements will be omitted.

Referring to FIG. 9, the blank period operation BLPO may be performed after the touch signal receiving period RSP. For example, the touch driving performing signal TDCS may be outputted after the touch signal receiving period RSP. For example, the touch driving performing signal TDCS may be outputted immediately after the touch signal receiving period RSP. The blank period operation BLPO may be performed after the touch signal receiving period RSP in the blank period BLK. In the present embodiment, the blank period operation BLPO may be performed in the touch calculating period CSP. In other words, the blank period operation BLPO may overlap with the touch driving operation TCO.

The touch driver 700 of the display device may output the touch driving performing signal TDCS after the touch signal receiving period RSP. The display panel driver 10 may perform the blank period operation BLPO in response to the touch driving performing signal TDCS. Accordingly, a signal interference between the touch driving operation TCO and the blank period operation BLPO may be reduced. As the signal interference is reduced, the reliability of the blank period operation BLPO may be improved. Additionally, as the signal interference is reduced, the reliability of the touch driving operation TCO may be improved. Additionally, the display panel driver 10 may perform the blank period operation BLPO in response to the touch driving performing signal TDCS, allowing for an increase in the type of the blank period operations BLPO that can be performed in the blank period.

Additionally, when the touch sensing data calculating operation is performed on the touch sensing data TSD, the signal interference may be reduced. For example, when the touch sensing signal calculating operation is performed, a signal exchange between the touch panel 800 and the touch driver 700 may be reduced. This reduction in signal exchange helps to mitigate signal interference. In the present embodiment, the blank period operation BLPO may be performed in the touch calculating period CSP, thereby ensuring that sufficient time is allocated for the blank period operation BLPO. By securing the necessary time for the blank period operation BLPO, the reliability of the blank period operation BLPO may be further improved.

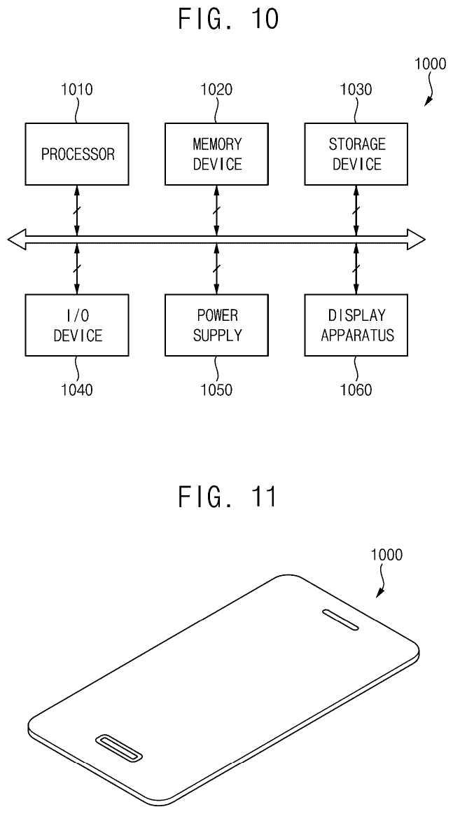

FIG. 10 is a block diagram illustrating an electronic device 1000 according to an embodiment of the present inventive concept. FIG. 11 is a diagram illustrating an example in which the electronic device of FIG. 10 is implemented as a smart phone.

Referring to FIG. 10, the electronic device 1000 may include a processor 1010, a memory device 1020, a storage device 1030, an input/output (I/O) device 1040, a power supply 1050, and a display apparatus 1060. Here, the display apparatus 1060 may be the display device of FIG. 1. In addition, the electronic device 1000 may further include a plurality of ports for communicating with a video card, a sound card, a memory card, a universal serial bus (USB) device, another electronic device, etc.

In an embodiment, as illustrated in FIG. 11, the electronic device 1000 may be implemented as a smart phone. However, the electronic device 1000 is not limited thereto. For example, the electronic device 1000 may be implemented as a cellular phone, a video phone, a smart pad, a smart watch, a tablet personal computer (PC), a car navigation system, a computer monitor, a laptop, a head mounted display (HMD) device, and the like.

The processor 1010 may perform various computing functions or various tasks. The processor 1010 may be a micro-processor, a central processing unit (CPU), an application processor (AP), and the like. The processor 1010 may be coupled to other components via an address bus, a control bus, a data bus, etc. Further, the processor 1010 may be coupled to an extended bus such as a peripheral component interconnection (PCI) bus.

The processor 1010 may output the input image data IMG, and the input control signal CONT to the driving controller 200 of FIG. 1.

The memory device 1020 may store data for operations of the electronic device 1000. For example, the memory device 1020 may include at least one non-volatile memory device such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, a ferroelectric random access memory (FRAM) device, and the like, and/or at least one volatile memory device such as a dynamic random access memory (DRAM) device, a static random access memory (SRAM) device, a mobile DRAM device, and the like.

The storage device 1030 may include a solid state drive (SSD) device, a hard disk drive (HDD) device, a CD-ROM device, and the like. The I/O device 1040 may include an input device such as a keyboard, a keypad, a mouse device, a touch-pad, a touch-screen, and the like, and an output device such as a printer, a speaker, and the like. In some embodiments, the display apparatus 1060 may be included in the I/O device 1040. The power supply 1050 may provide power for operations of the electronic device 1000. The display apparatus 1060 may be coupled to other components via buses or other communication links.

Referring to FIG. 11, the electronic device 1000 of the present inventive concept is shown implemented as a smartphone, but the present inventive concept is not limited thereto. The electronic device 1000 may be a television, a monitor, a laptop computer, or a tablet. Additionally, the electronic device 1000 may be a car.

The display device according to the embodiments of the present inventive concept may be applied to a display device included in a computer, a notebook, a mobile phone, a smart phone, a smart pad, a portable media player (PMP), a personal digital assistant (PDA), an MP3 player, or the like.

The foregoing is illustrative of the present inventive concept and is not to be construed as limiting thereof. Although a few embodiments of the present inventive concept have been described, those skilled in the art will readily appreciate that many modifications can be made without materially departing from the scope of the present inventive concept. Accordingly, all such modifications are intended to be included within the scope of the present inventive concept as set forth in the claims.

What is claimed is:

1. A display device comprising:
a display panel including a pixel;
a touch panel including a touch sensor; and
a display panel driver configured to perform a data writing operation to the pixel in an active period and perform a touch driving operation to the touch sensor in a blank period,
wherein the display panel driver includes a touch driver configured to perform the tough driving operation and a driving controller configured to control an operation of the display panel and the touch driver, and
wherein the touch driver outputs a touch driving performing signal, which indicates that the touch driving operation was performed, in the blank period to the driving controller.

2. The display device of claim 1, wherein the touch driver receives an active period completion signal from the driving controller and performs the touch driving operation in response to the active period completion signal.

3. The display device of claim 1, wherein a touch driving period in which the touch driving operation is performed includes a touch signal applying period in which a touch signal is applied to the touch panel, a touch signal receiving period in which a touch sensing signal is applied to the touch driver, and a touch calculating period in which the touch sensing signal is calculated, and
wherein the touch driver outputs the touch driving performing signal after the touch calculating period.

4. The display device of claim 1, wherein a touch driving period in which the touch driving operation is performed includes a touch signal applying period in which a touch signal is applied to the touch panel, a touch signal receiving period in which a touch sensing signal is applied to the touch driver, and a touch calculating period in which the touch sensing signal is calculated, and
wherein the touch driver outputs the touch driving performing signal after the touch signal receiving period.

5. The display device of claim 1, wherein a touch driving period in which the touch driving operation is performed includes a touch signal applying period in which a touch signal is applied to the touch panel and a touch signal receiving period in which a touch sensing signal is applied to the touch driver, and
wherein the touch driver outputs the touch driving performing signal after the touch signal receiving period.

6. The display device of claim 5, wherein the touch driver outputs the touch driving performing signal immediately after the touch signal receiving period.

7. The display device of claim 1, wherein the display panel driver further includes a sensing driver, and
wherein the sensing driver performs a sensing operation to the pixel based on the touch driving performing signal.

8. The display device of claim 7, wherein the driving controller outputs a sensing start signal to the sensing driver in response to the touch driving performing signal, and
wherein the sensing driver performs the sensing operation in response to the sensing start signal.

9. The display device of claim 8, wherein the touch driver includes:
a completion signal receiving circuit configured to receive an active period completion signal from the driving controller;
a touch signal applying circuit configured to apply a touch signal to the touch sensor in response to the active period completion signal;
a touch sensing signal receiving circuit configured to receive a touch sensing signal from the touch sensor and to output a sensing completion signal; and
a completion signal outputting circuit configured to receive the sensing completion signal and to output the touch driving performing signal.

10. The display device of claim 9, wherein the touch driver further includes a touch sensing signal calculating circuit configured to calculate the touch sensing signal,
wherein the touch sensing signal calculating circuit outputs a calculating completion signal to the completion signal outputting circuit, and
wherein the completion signal outputting circuit outputs the touch driving performing signal in response to the calculating completion signal.

11. The display device of claim 1, wherein the driving controller generates a blank operating signal in response to the touch driving performing signal.

12. A display device comprising:
a display panel including a pixel;
a touch panel including a touch sensor; and
a display panel driver configured to perform a data writing operation to the pixel in an active period and perform a touch driving operation to the touch sensor in a blank period,
wherein the touch driving operation includes:
a touch signal applying operation in which a touch signal is applied to the touch panel;
a touch sensing signal receiving operation in which a touch sensing signal is received from the touch panel; and
a touch sensing signal calculating operation in which touch sensing data is calculated based on the touch sensing signal, and
wherein the display panel driver generates a touch driving performing signal after the touch sensing signal receiving operation is performed.

13. The display device of claim 12, wherein the touch driving performing signal is generated after the touch sensing signal calculating operation is performed.

14. The display device of claim 12, wherein the display panel driver includes:
a touch driver configured to perform the touch driving operation; and
a driving controller configured to control an operation of the display panel and the touch driver, and
wherein the touch driver outputs the touch driving performing signal to the driving controller.

15. The display device of claim 14, wherein the driving controller outputs an active period completion signal to the touch driver, and
wherein the touch driver performs the touch driving operation in response to the active period completion signal.

16. The display device of claim 14, wherein the driving controller generates a blank operating signal in response to the touch driving performing signal.

17. The display device of claim 16, wherein the display panel driver further includes a sensing driver configured to perform a sensing operation to the pixel,
wherein the blank operating signal includes a sensing start signal, and
wherein the sensing driver performs the sensing operation in response to the sensing start signal.

18. A touch driver comprising:
a completion signal receiving circuit configured to receive an active period completion signal;
a touch signal applying circuit configured to generate a touch signal in response to the active period completion signal;
a touch sensing signal receiving circuit configured to receive a touch sensing signal generated by a touch sensor based on the touch signal; and
a completion signal outputting circuit configured to receive a sensing completion signal from the touch sensing signal receiving circuit and to output a touch driving performing signal to a driving controller.

19. The touch driver of claim 18, further comprising a touch sensing signal calculating circuit configured to calculate the touch sensing signal.

20. The touch driver of claim 19, wherein the touch sensing signal calculating circuit outputs a calculating completion signal to the completion signal outputting circuit, and
wherein the completion signal outputting circuit outputs the touch driving performing signal in response to the calculating completion signal.
